(19) United States
(12) Patent Application Publication
(10) Pub. No.: US 2014/0335273 A1
(43) Pub. Date: Nov. 13, 2014

(54) TRANSFER METHOD FOR PRODUCING THERMOPLASTIC COATINGS FOR FLOOR TILES

(71) Applicant: SÜDDEKOR GMBH, Laichingen (DE)

(72) Inventor: Heinz Haller, Plochingen (DE)

(21) Appl. No.: 14/362,204

(22) PCT Filed: Dec. 10, 2012
(86) PCT No.: PCT/EP2012/005094

§ 371 Date: Jun. 2, 2014

(30) Foreign Application Priority Data
Dec. 9, 2011 (DE) 10 2011 120 702.7

(51) Int. Cl. B05D 5/06

(52) U.S. Cl. CPC B05D 5/06
USPC 427/256

(57) ABSTRACT

The present invention relates to a process for the production of a decorative, abrasion-resistant laminate in which a thermoplastic wearlayer is applied to a substrate by means of a transfer process. The present invention further relates to the use of the laminate produced via the process of the invention for flexible and rigid floorcoverings.

The present invention relates to a process for the production of a decorative, abrasion-resistant laminate in which a thermoplastic wearlayer is applied to a substrate by means of a transfer process. The present invention further relates to the use of the laminate produced via the process of the invention for flexible and rigid floorcoverings.

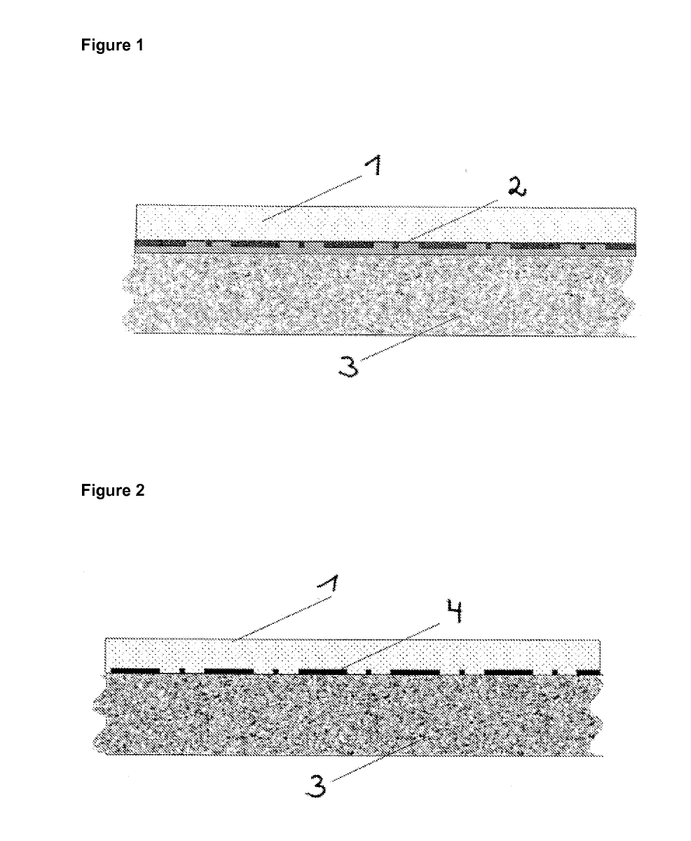

The prior art discloses the production of what are known as LVTs (Luxury Vinyl Tiles), which are used as floorcovering tiles that can be directly adhesive-bonded. These LVTs are usually composed of a plastics substrate, mostly polyvinyl chloride (PVC), of a printed foil (known as the printfilm or decorative film), likewise composed of PVC, and of a transparent wearlayer which prevents damage to the decorative effect applied on the printfilm (see FIG. 1). The transparent wearlayer here is mostly composed of PVC or of other transparent plastics, and can either be smooth or have a structure. If a structured wearlayer is desired, this is generally realized via embossing of the wearlayer. The thickness of the wearlayer can usually be up to 1 mm, and is also a measure of the abrasion resistance of the floorcovering tile.

More recent developments have revealed that it is also possible to produce plastics tiles of the abovementioned type in a manner that removes the requirement for direct adhesive bonding of the tile to the underlying material. This is rendered possible by providing the substrate with an interlock system which permits mechanical or interlocking of the individual tiles without external assistance, so that the entire covering can be laid without use of any other means of fixing. The substrate here can be composed either of plastic or of a wood-plastic mixture, or of wood-based materials.

It is an object of the present invention to provide a process which permits production of a laminate, for example for flexible and rigid floorcovering tiles. In particular, the intention is to provide a process which permits application of a thermoplastic wearlayer to a substrate in a manner such that a water-resistant and abrasion-resistant laminate can thus be produced for floorcovering tiles. The process of the invention is moreover also intended to be capable of achieving decorative and haptic properties of the laminate such that the laminate surface is regular and synchronous in respect of its haptic and optic properties.

Said object is achieved via the embodiments of the present invention which are characterized in the claims.

In particular, the invention provides a process for the production of a decorative, abrasion-resistant laminate, where the process comprises the following steps:
(a) application of a thermoplastic as melt to a flexible carrier web, the surface of which has slightly adhesive properties, in order to form a thermoplastic wearlayer;
(b) cooling of the thermoplastic wearlayer located on the carrier;
(c) transfer of the wearlayer to a substrate via melting of the carrier web, provided with the wearlayer, onto the substrate at elevated temperature, thus forming a composite comprising, in this sequence, the substrate, the wearlayer, and the carrier;
(d) cooling of the composite; and
(e) removal of the carrier web from the wearlayer,
   where, after the step (b) and before the step (c), the thermoplastic wearlayer applied on the carrier web is provided with a reverse print, and the print image of the reverse print is positioned in such a way as to be synchronous with respect to the structure of the carrier web.

The term “decorative” means in the invention that the laminate has a single- or multicolor pattern and has a structured surface, in order to imitate optical and/or haptic properties of other coverings, such as ceramic tiles or wood parquet. The term “abrasion-resistant” means in the invention that the laminate is resistant to mechanical effects.

In the step (a) of the process of the invention, a thermoplastic is applied as melt to a flexible carrier web, the surface of which has slightly adhesive properties, in order to form a thermoplastic wearlayer.

The term “thermoplastic” is not subject to any restriction in the invention. It is preferable in the invention to use a thermoplastic which gives a thermoplastic wearlayer that has not only abrasion-resistant properties but also transparent properties. In one preferred embodiment, the thermoplastic used to form the thermoplastic wearlayer comprises polypropylene, thermoplastic polyurethane, thermoplastic polyamide, and/or thermoplastic polyester, or a combination thereof.

The application of the thermoplastic as melt to the carrier is not subject to any restriction. In one preferred embodiment, after melting in an extruder, the thermoplastic is applied to the carrier web with the aid of a slot die in order to form a thermoplastic wearlayer. The melting of the thermoplastic in the extruder here preferably takes place in the temperature range from 200° C. to 320° C., as required by the thermoplastic used: by way of example the melting of polypropylene preferably takes place at temperatures from 200° C. to 250° C., the melting of polyurethanes preferably takes place at temperatures from 170° C. to 220° C., the melting of polyamides preferably takes place at temperatures from 250° C. to 320° C., and the melting of polyesters preferably takes place at from 180° C. to 250° C. The hot melt film is then usually applied directly to the carrier in a nip. The quantity of the thermoplastic applied to the carrier in order to form the thermoplastic wearlayer is preferably in the range from 25 g/m² to 350 g/m². The thickness of the wearlayer depends on the density of the coating material, being preferably from 20 to 320 μm for polypropylene, from 30 to 450 μm for polyurethanes, and from 30 to 400 μm for polyamides.

In the step (b) of the process of the invention, the thermoplastic wearlayer located on the carrier is cooled. This is achieved by way of example in that, immediately after application of the thermoplastic in the step (a), the coated side of the carrier is passed around a chill roll where the melt solidifies and adapts the surface of the chill roll. The temperature to which the cooling of the thermoplastic wearlayer located on the carrier is carried out in the step (b) is from 80° C. to 20° C., preferably room temperature.

The only restriction to which the flexible carrier web is subject in the invention is that the surface of the carrier has slightly adhesive properties. The term “flexible” means in the invention that the carrier web can be passed over the guiding rolls of a commercially available coating machine. The expression “slightly adhesive properties” means in the invention that, after formation on the carrier in the step (a) and subsequent cooling in the step (b), the adhesion of the thermoplastic wearlayer to the carrier is sufficient to permit subsequent wind-up of the carrier with the applied wearlayer and introduction into possible further processing. On the other hand, however, the adhesion of the thermoplastic wearlayer to the carrier must also be sufficiently weak to permit subsequent separation of the carrier from the thermoplastic wearlayer at temperatures from 20° C. to 80° C. The surface of the carrier is defined by a gloss level and structure. In one preferred embodiment, the carrier is a structured release paper. The release paper is preferably composed of a coated paper or paperboard with a preferred thickness of from 150 to 250 μm, where the paper or the paperboard has been coated with a heat-resistant release coating.

In the step (c) of the process of the invention, the wearlayer is transferred to a substrate. This transfer is achieved via melting of the carrier web, provided with the wearlayer, onto the substrate at elevated temperature. A composite is thus formed which comprises, in this sequence, the substrate, the wearlayer, and the carrier.

The term “substrate” is not subject to any restriction in the invention; it is possible to use either rigid or flexible substrates. In one preferred embodiment, the substrate of the invention is a rigid substrate composed of sheets of wood-based material (e.g. HDF, MDF, particleboard, OSB), sheets of plastics mixtures (e.g.

polyvinyl chloride, polypropylene), wood-plastics mixtures (e.g. WPC), or gypsum plasterboard. In an alternatively preferred embodiment, the substrate is a flexible substrate composed of polyvinyl chloride, polypropylene, polyurethane, polyester, or a mixture of various plastics with preferred thicknesses of from 1 to 6 mm.

By virtue of the elevated temperature in the step (c), the thermoplastic wearlayer melts, and it thus bonds at least adhesively to the substrate. In one preferred embodiment of the present invention, the melting is carried out in the temperature range from 180° C. to 220° C. The required temperature here is by way of example brought about electrically or via plates, tapes, or rolls heated by hot fluid, and is thus transferred to the composite.

In the next step (d) of the process of the invention, the composite formed in the step (c), comprising the substrate, the wearlayer, and the carrier, is cooled. By way of example, the composite is cooled here between water-cooled rolls, belts, or plates. The temperature range to which cooling is carried out is preferably from 20° C. to 80° C.

In the step (e) of the process of the invention, the carrier web is removed from the wearlayer; the material that remains is the finished laminate, comprising the thermoplastic wearlayer and the substrate, where the wearlayer has been bonded at least adhesively to the substrate. The removal of the carrier is preferably carried out at the temperature to which cooling is carried out in the step (d) of the process of the invention, since within this temperature range the carrier web has only a low level of adhesive properties, and can easily be removed from the wearlayer. The carrier web can then be wound up, any remaining residues being removed from the carrier surface via appropriately known cleaning devices, for example brushes or blowers. The carrier web can then be reused as carrier in the step (a) of the process of the invention.

The structuring of the surface of the wearlayer is determined via the surface structure of the carrier web. This surface structure can be realized via embossing or molding of the carrier. In the step (a) of the process of the invention, the thermoplastic wearlayer is formed via application of a melt of a thermoplastic, and the wearlayer therefore adapts the surface structure of the carrier. It is thus advantageously possible to transfer not only the gloss level of the carrier but also structures with depths up to 150 μm to the thermoplastic wearlayer.

After the step (b) and before the step (c) in the invention, the surface of the thermoplastic wearlayer applied on the carrier web is provided with a reverse print, which is applied in the form of a mirror image. After the melting of the wearlayer in the step (c), the location of the reverse print is on that side of the wearlayer that is in contact with the surface of the substrate (see FIG. 2), and the reverse print thus has protection from mechanical damage via abrasion, and from water. The reverse print of the invention serves as surface decoration, and it is thus advantageously possible to omit the introduction of a printfilm for decorative purposes. Precondition for this procedure is that the substrate has a surface of uniform color. In one preferred embodiment of the present invention, the reverse print is achieved by a solvent-free intaglio printing process or by a solvent-free digital printing process.

The print image of the reverse print in the invention is positioned in such a way that it is synchronous with respect to the structure of the carrier web. For this purpose, by way of example, markings are applied during the embossing of the carrier, and these can be detected and processed during the application of the reverse print of the thermoplastic, transparent wearlayer, in order to achieve said positioning. In this way it is possible to produce a laminate with surface that is regular and synchronous in respect of its optic and haptic properties. This procedure is by way of example used in the production of wood-imitation effects where the intention is that wherever wood pores are represented visually they should also be detectable by touch.

The present invention further provides the use of the laminate produced via the process of the invention for flexible and rigid floorcoverings.

The present invention permits the production of an abrasion-resistant laminate by means of a transfer process. The process advantageously permits provision of a decorative effect to the laminate during the production process. The decorative effect is achieved here by way of a reverse print, thus permitting omission of a printfilm, with cost advantage. The wearlayer of the laminate is moreover also advantageously provided with haptic properties via structuring of the carrier of the invention. The laminate produced in the invention has excellent suitability for the use by way of example for floorcovering tiles. It is advantageously possible in the process of the invention, by combining printing and structuring, to imitate not only the optical but also the haptic properties of conventional floorcoverings, such as ceramic tiles or parquet floors.

The figures show the following:

FIG. 1: A diagram of the structure of LVTs (Luxury Vinyl Tiles)

FIG. 2: A diagram of the structure of a laminate produced in the invention with reverse print

### KEY

1 Wearlayer
2 Decorative film (printfilm)
3 Substrate
4 Reverse print

1. A process for the production of a decorative, abrasion-resistant laminate, comprising the following steps:
(a) application of a thermoplastic as melt to a flexible carrier web, the surface of which has slightly adhesive properties, in order to form a thermoplastic wearlayer;
(b) cooling of the thermoplastic wearlayer located on the carrier;
(c) transfer of the wearlayer to a substrate via melting of the carrier web, provided with the wearlayer, onto the substrate at elevated temperature, thus forming a composite comprising, in this sequence, the substrate, the wearlayer, and the carrier;
(d) cooling of the composite; and
(e) removal of the carrier web from the wearlayer,
where, after the step (b) and before the step (c), the thermoplastic wearlayer applied on the carrier web is provided with a reverse print, and the print image of the reverse print is positioned in such a way as to be synchronous with respect to the structure of the carrier web.

2. The process as claimed in claim 1, where that side of the surface of the carrier web on which the thermoplastic wearlayer is applied in the step (a) has a structure, and during the lamination in the step (c) the wearlayer adapts the surface structure of the carrier.

3. The process as claimed in claim 1, where the carrier web is a structured release paper.

4. The process as claimed in claim 1, where the thermoplastic wearlayer comprises polypropylene, thermoplastic polyurethane, thermoplastic polyester, and/or thermoplastic polyamide, or a combination thereof.

5. The process as claimed in an claim 1, where the substrate is a rigid substrate selected from the group consisting of sheets of wood-based material, sheets of plastics mixtures, wood-plastics mixtures, and gypsum plasterboard, or a flexible substrate selected from the group consisting of polyvinyl chloride, polypropylene, polyurethane, polyester, and mixtures of various plastics.

6. The process as claimed in claim 1, where, in the step (a) after melting of the thermoplastic in an extruder, the thermoplastic wearlayer is applied to the carrier web with the aid of a slot die.

7. The process as claimed in claim 1, where the quantity of the thermoplastic applied to the carrier in the step (a) is from 25 g/m² to 350 g/m².

8. The process as claimed in claim 1, where the reverse print is achieved by a solvent-free intaglio printing process or by a solvent-free digital printing process.

9. The process as claimed in claim 1, where the melting in the step (c) is carried out at from 180 to 220° C.

10. The process as claimed in claim 1, where the temperature to which cooling is carried out in the step (d) is from 60 to 80° C.

11. The process as claimed in claim 1 wherein the laminate produced is suitable for use for flexible and rigid floorcoverings.
